(19) United States
(12) Patent Application Publication
(10) Pub. No.: US 2007/0052348 A1
(43) Pub. Date: Mar. 8, 2007

(54) Plasma display panel

(76) Inventors: Masashi Goto, Osaka (JP); Mikihiko Nishitani, Nara (JP); Katsumi Adachi, Nara (JP); Yoshinori Yamada, Osaka (JP); Satoshi Ikeda, Osaka (JP)

Correspondence Address: SNELL & WILMER L.L.P., 600 ANTON BOULEVARD, SUITE 1400, COSTA MESA, CA, 92626, US

(21) Appl. No.: 10/576,671

(22) PCT Filed: Oct. 28, 2004
(86) PCT No.: PCT/JP04/16023

§ 371 Date: Apr. 21, 2006

(30) Foreign Application Priority Data
Oct. 30, 2003 (JP) 2003-370379

(51) Int. Cl. H01J 1/62

(52) U.S. Cl. 313/505

(57) ABSTRACT

The present invention is a plasma display panel in which a plurality of pairs of display electrodes extending in a row direction are disposed on a surface of a first substrate and a plurality of discharge cells are formed along each pair of display electrodes, wherein, at least within each discharge cell, each display electrode of the pair of display electrodes comprises a bus line and a band-shaped electrode member that is electrically connected to the bus line, the band-shaped electrode member extending in the row direction and being disposed at least mainly on a same side of the bus line as a gap between the pair of display electrodes, and each band-shaped electrode member has at least one cut-out formed from a gap-side edge towards the bus line, each cut-out having a length that is shorter than a distance between the gap-side edge and the bus line. When the plasma display panel is driven, peaks in electric field intensity are respectively formed in the discharge cell in regions of the electrode member on both sides of the cut-outs. Here, The display electrodes can be constructed from bus lines and transparent electrodes both extending in the row direction, and the band-shaped electrode member can be a transparent electrode.

### TECHNICAL FIELD

The present invention relates to a plasma display panel for use in an information display device, flat screen television, or the like.

### BACKGROUND ART

A plasma display panel (referred to hereafter as “PDP”), which is a type of gas discharge panel, is a self-emitting FPD (flat display panel) that displays images by causing excitation and emission in a phosphor via ultra-violet light generated by gas discharge. A PDP is classified, according to the way it is powered, as being either an alternating current (AC) type or a direct current (DC) type. The AC-type has characteristics that are preferable to those of the DC-type in areas such as luminance, emission efficiency, lifetime, and the like. Among AC-type models, the reflection type surface discharge model in particular has outstanding luminance and emission efficiency characteristics, and is widely employed in such applications as computer displays, large television monitors, and display devices for industrial use.

FIG. 15 is a partial cross section in perspective view showing the main constituents of a normal AC-type PDP. In the figure, the z-direction is the thickness direction of the PDP and the xy-plane corresponds to a plane parallel to the panel surfaces in the PDP. As shown in the figure, a PDP 1 is principally constructed from a front panel FP and a back panel BP, main surfaces of which are disposed opposing each another.

On a main surface of a front panel glass 2, which is to form the substrate for the front panel FP, multiple pairs of display electrodes 4 and 5 (scan electrode 4 and sustain electrode 5) extending in the x-direction are provided, such that surface discharge (sustain discharge) takes place with gaps between each pair of display electrodes 4 and 5 as main discharge gaps. The display electrodes of 4 and 5 of FIG. 15 are constructed from transparent electrodes 400 and 500, which are composed of wide bands of an ITO (Indium Tin Oxide) material, and bus lines 401 and 501, which are composed of a metallic material and laminated onto the transparent electrodes 400 and 500.

The various scan electrodes 4 are electrically independent, and are supplied with electricity separately. The various sustain electrodes 5, on the other hand, are electrically connected so as to be at the same potential.

On the main surface of the front panel glass 2, on which the display electrodes 4 and 5 are provided, coats of a dielectric layer 6 composed of an insulating material and a protective layer 7 composed of Magnesium Oxide are applied in the stated order so as to cover the display electrodes 4 and 5.

A plurality of address (data) electrodes 11 are provided in a stripe pattern extending in the y-direction on one main surface of a back panel glass 3, which is the substrate for the back panel BP. These address electrodes 11 are formed by, for instance, firing a compound material containing glass and Ag.

On the main surface of the back panel glass 3, on which the address electrodes 11 are provided, a coat of a dielectric layer 10 composed of an insulating material is applied so as to cover the address electrodes 11. Barrier ribs 30 whose length direction lies in the y- direction are provided on the dielectric layer 10 in the gaps between adjacent address electrodes 11. Further, a phosphor layer 9R, 9G or 9B corresponding to one of red (R), green (G), or blue (B) and having an arc-shaped profile is formed on the surf ace of the dielectric layer 10, between the side-walls of each pair of adjacent barrier ribs 30.

The above front panel FP and back panel BP pair are disposed opposite each other such that length directions of the address electrodes 11 and the display electrodes 4 and 5 are perpendicular.

The front panel FP and the back panel BP are sealed together at their respective perimeters using a seal member such as a glass frit, or the like, to hermetically seal an internal space between the panels FP and BP. A discharge gas, such as Ne—Xe type (including 5%-30% Xe), is enclosed in the sealed internal part of the front panel FP and back panel BP at a prescribed pressure (commonly in the range 40 kPa-66.5 kPa).

Between the front panel FP and the back panel BP spaces formed between the dielectric layer 6 and the phosphor layers 9R, 9G, 9B, and partitioned by two adjacent barrier ribs 30 form a discharge space 38. Further, regions where the pairs of display electrodes 4 and 5 and the single address electrodes 11 cross over sandwiching a portion of discharge space 38 therebetween correspond to discharge cells 8 (see FIG. 1) for displaying an image.

When a PDP is driven, gradation display of a single image is achieved by a process of starting, in specified discharge cells 8, an address discharge between the address electrode 11 and one of the display electrodes 4 or 5, generating short wave ultra-violet light (Xe resonance line at wavelength of approximately 147 nm) via a sustain discharge using the pair of display electrodes 4 and 5, and the phosphor layer 9R, 9G or 9B that receives the ultra-violet light emitting visible light. An image is displayed with gradation using a field gradation display method, a commonly used image display method, in which periods with different discharge counts (sub-fields) are selected according to the desired gradation.

PDPs of this type have thin screens and excellent moving picture quality, but in comparison to liquid crystal displays with similar thin screens, consume more power and have a higher peak current at emission, and control of these properties is therefore a problem.

Further, in terms of structure, since there is no clear partition between adjacent discharge cells 8 in they-direction, when a specified discharge cell in a prescribed position discharges and emits during PDP operation, charged particles and the like leak into adjacent cells, and erroneous discharge sometimes occurs. This erroneous discharge leads to a reduction in resolution, which causes a deterioration in image quality, and a solution to this problem is therefore desired.

A method for reducing the peak current in order to reduce the power consumption has been proposed, for example, in Japanese laid-open patent application No. H08-315735 (page 4 and FIG. 1). In this method, each display electrode is split along its length to form a plurality of electrodes, thereby splitting the peak current into a plurality of peak currents.

Further, a method for preventing erroneous discharge in a PDP has been proposed in Japanese laid-open patent application No. 2000-133149 (page 4 and FIG. 7), which describes a method for providing an electric field concentration area in the center of the discharge cell by forming two pairs of electrode segments in the display electrodes in each discharge cell.
Patent Document 1: Japanese laid-open patent application No. H08-315735
Patent Document 2: Japanese laid-open patent application No. 2000-133149

### DISCLOSURE OF THE INVENTION

### Problems that the Present Invention Aims to Solve

However, the method of splitting the display electrodes lengthwise as in Japanese laid-open patent application No. H08-315735 is problematic in that the firing voltage increases to make up for splitting the peak discharge current. This is undesirable because an increase in the firing voltage, in addition to increasing power consumption, increases cost because of the necessity of increasing the load resistance of the driver IC that applies voltages to the display electrodes.

Moreover, in the method described in Japanese laid-open patent application No. 2000-133149, while, on one hand, erroneous discharge is prevented, on the other, not only does peak current at discharge increase, but because the electric field is concentrated in the center of the discharge cell, the discharge intensity is highest at a central portion, and it is difficult to make effective use of the whole discharge space of the discharge cell. Further, with this construction there is the further problem of luminance being likely to drop, even for a comparatively high reactive power, on account of the electrode segments being closely spaced.

Hence, satisfactorily solving the stated problems is difficult, whichever of the above described methods is adopted. Further, though, by using these methods, the area of the display electrodes is reduced compared with conventional constructions, there is a risk of the separate problem of a drop in luminance occurring.

The present invention was conceived to solve the stated problems and has a first object of providing a PDP having a suppressed firing voltage and a superior emission efficiency with a reduced power consumption.

Further, a second object is to provide a PDP in which a favorable image display performance can be realized, even while achieving a reduction in reactive power, by suppressing any reduction in luminance.

Moreover, a third object is to provide a PDP in which the occurrence of erroneous discharge due to crosstalk and the like is rare.

Means for solving Stated Problems and Effects of the Invention

In order to solve the stated problems, the present invention is a plasma display panel in which a plurality of pairs of display electrodes extending in a row direction are disposed on a surface of a first substrate and a plurality of discharge cells are formed along each pair of display electrodes, wherein at least within each discharge cell, each display electrode of the pair of display electrodes comprises a bus line and a band-shaped electrode member that is electrically connected to the bus line, the band-shaped electrode member extending in the row direction and being disposed at least mainly on a same side of the bus line as a gap between the pair of display electrodes, and each band-shaped electrode member has at least one cut-out formed from a gap-side edge towards the bus line, each cut-out having a length that is shorter than a distance between the gap-side edge and the bus line.

Here, each bus line can be composed of a metallic material and each band-shaped electrode member can be a transparent electrode member.

According the present invention of the above construction, when voltages are applied to the pair of display electrodes during operation, electric field intensity peaks are formed at a plurality of band electrode member regions existing to either side of each cut-out, and discharges occur thereat. As the electric field is concentrated at each of these peak positions, a favorable start to the discharge is possible, even at a comparatively low firing voltage.

Subsequently, in correspondence with the positions of these peaks in field intensity, multiple discharges occur and expand, forming a discharge of satisfactory scale across the discharge cell as a whole. During this period, in the present invention, the build-up of unnecessary charge, a cause of reactive power, is effectively prevented on account of the electrode surface area being partially removed via the cut-outs, and a reduction in power consumption is consequently achieved.

Thus, according to the construction of the present invention, the luminance required to obtain satisfactory image display performance can be acquired while a reduction in the power consumption is achieved.

The shape of the cut-outs may be designed as appropriate, and for example, can be any of rectangular, wedge-shaped, polygonal, and circular.

Further, it is possible to use a construction in which the first substrate opposes a second substrate across a discharge space, a plurality of address electrodes being disposed on the second substrate in a stripe pattern, and in each discharge cell, the cut-outs in the pair of display electrodes are located opposite each other, and the first substrate and the second substrate are arranged so that the cut-outs are in correspondence with an address electrode that is in the discharge cell.

Thus, in the present invention, by adjusting the relative positions of the cut-outs and the address electrode, the firing position, which is the crossover area (effective discharge area) at which the address electrode and display electrodes cross-over sandwiching the discharge space, is secured to some extent. This arrangement is desirable because address discharge can occur more easily and erroneous addressing and discharge time lag can be suppressed.

Further, on the first substrate, a first dielectric layer and a protective layer can form layers in the stated order so as to cover the display electrodes, and in each discharge cell, on the protective layer, a second dielectric layer can be provided in correspondence with positions of the cut-outs.

Using the second dielectric layer in this way enables the plurality of electric field intensity peaks to be formed with increased reliability and the discharge of a satisfactory scale to be obtained.

Further, as an alternative construction, the present invention can be a plasma display panel in which a plurality of pairs of display electrodes extending in a row direction are disposed on a surface of a first substrate and a plurality of discharge cells are formed along each pair of display electrodes, wherein at least within each discharge cell, each display electrode of the pair of display electrodes includes a bus line and a band-shaped base part, which both extend in the row direction, and a plurality of opposing parts that are disposed in the gap between the pair of display electrodes and that are electrically connected to the base parts, peaks in electric field intensity being formed at the opposing parts of each display electrode.

With this construction too, electric field intensity peaks are formed in correspondence with opposing parts that form pairs across the gap between the electrodes. Further, since gaps between adjacent opposing parts of the same polarity achieve beneficial effects similar to those achieved using the cut-outs, beneficial effects similar to those of the cut-out construction can be achieved as regards reduced reactive power and power consumption.

Moreover, each bus line can be composed of a metallic material and each band-shaped base part and each opposing part can be composed of a transparent electrode material.

Here, each opposing part can include a connecting part extending in the column direction and a discharge part extending from the connecting part in the row direction, and a main discharge gap can exist in each location at which two discharge parts belonging to the respective band-shaped electrode members of each pair of display electrodes oppose each other.

Specifically, each discharge part can be band-shaped and have a length in the row direction.

Moreover, the first substrate can be disposed opposite a second substrate on which a plurality of address electrodes are disposed in a stripe form, in each discharge cell, opposing parts belonging to the respective electrode members of the pair of display electrodes can be located opposite each other, and the first substrate and the second substrate can be arranged so that each gap between opposing parts that are adjacent and of the same polarity corresponds with a position of the address electrode in the discharge cell.

Here, in each discharge cell, the opposing parts can be disposed symmetrically about the address electrode.

Thus, according to a PDP of the present invention, a superior image display performance can be realized as a result of being able to drive the PDP at a favorable power consumption and as a result of effects such as improved luminance, cross-talk prevention and being able to prevent erroneous discharge.

### BEST MODE FOR CARRYING OUT THE INVENTION

Embodiments of the PDP of the present invention are successively described below, with reference to drawings.

As the main distinguishing characteristics of the PDP of the present invention are in the construction of the discharge cells shown in FIG. 1 to FIG. 4 below, and as the construction of the present invention otherwise substantially resembles the conventional construction of the PDP 1 in FIG. 15, potentially repetitive descriptions of similar parts outside the discharge cells have been omitted.

### First Embodiment

The First Embodiment relates to a PDP in which the reactive power can be reduced and the firing voltage lowered.

FIG. 1 is a plan view of the construction of a discharge cell of the First Embodiment.

In FIG. 1, the pair of display electrodes 4 and 5 are constructed from bus lines 401 and 501, which are composed of a silver material and extend in the x-direction, and, extending in the same x-direction, band-shaped base parts 402 and 502 and opposing parts 406a, 406b, 506a and 506b, which are composed of a transparent material and is substantially disposed on the same side of the bus lines 401 and 501 as the gap between the pair of display electrodes 4 and 5.

Further, the opposing parts 406a, 406b, 506a and 506b are composed of a plurality (here, a total of 4 in the discharge cell 8) of main discharge parts 408a, 408b, 508a and 508b, which are arranged in opposing pairs, and connecting parts 407a, 407b, 507a and 507b, which respectively connect the rectangular main discharge parts 408a, 408b, 508a and 508b to the band-shaped base parts 402 and 502.

The opposing parts 406a, 406b, 506a and 506b, formed by respectively connecting the main discharge parts 408a, 408b, 508a and 508b to the connecting parts 407a, 407b, 507a and 507b to form L-shaped hooks, are arranged to be symmetrical about the address electrode 11, which extends in the y-direction, and the main discharge parts 408a, 408b (508a, 508b) of the same polarity are provided apart from each other so as to form a gap GG therebetween. In this arrangement, the space between the main discharge parts 408a and 408b (508a and 508b) is a cut-out 409 (509). In the gap between the pair of display electrodes 4 and 5, it is necessary that the cut-out 409 (509) is formed, as shown in FIG. 1, extending from a y-direction edge of the mutually opposing main discharge parts 408a and 408b (508a, 508b) towards the bus line 401 (501), but not with sufficient length to reach thereto.

Here, the gap GG is set to be narrower than a width of the address electrode 11, and via its location directly over the address electrode 11, is provided so as to be contained within an area of the address electrode 11 when viewed from above, as seen in FIG. 1.

The band-shaped base parts 402 and 502 and the opposing parts 406a, 406b, 506a, and 506b in the drawing are generally constructed from a transparent electrode material such as ITO, and are arranged so as to form band-shaped electrode members across the whole panel.

Example dimensions are 60 μm for the gap GG, 130 μm for an x-direction width of the main discharge parts 408a, 408b, 508a and 508b, 65 μm for an x-direction width of the connecting parts 407a, 407b, 507a and 507b, and 40 μm for a main discharge gap G width, but the effects of the present invention are by no means limited to a construction with these values. Note that appropriate dimensions and forms for cut-outs 409 and 509 are described below together with example data.

In the example of FIG. 1, the barrier ribs 30 composed of column-direction sections 301 and row-direction sections (auxiliary barrier ribs) 302 are constructed in a matrix formation, but this is in order to prevent cross-talk, and barrier ribs with a stripe form similar to that in conventional PDPs are also acceptable.

In the First Embodiment, the bus lines 401 and 501 are constructed from a silver material, and the main discharge parts 408a, 408b, 508a and 508b and the connecting parts 407a, 407b, 507a, and 507b, from a transparent electrode material such as ITO, but the present invention is not limited to using these materials, and can be constructed using other conductive materials.

Note also that, though a black matrix BM (also known as a black stripe) for improving color reproduction is provided extending along the column-direction sections 301 of the barrier ribs 30, this is not an essential component of the present invention, and can be provided or omitted as desired.

According to the PDP 1 of the First Embodiment having the above construction, as a result of the gap GG being narrower than the width of the address electrode 11 and being positioned directly over the address electrode 11, the firing positions of the main discharge parts 408a, 408b, 508a and 508b are close to the address electrode 11. Because of this, when the PDP is driven, address discharge occurs more easily, and the beneficial effect of suppressing the problems of erroneous addressing and discharge time-lag is achieved. If a large cut-out exists at the position where the address electrode and display electrodes (especially the scan electrode 4) cross over and sandwich the discharge space 38, the area of the cross-over is drastically reduced (i.e. the effective discharge area is reduced), and the address discharge becomes unstable, but in the First Embodiment, by securing the area of the crossover (the effective discharge area) to some extent in the manner described above, these kind of address discharge problems are eliminated.

Moreover, since in the discharge cell 8 the main discharge parts 408a, 408b, 508a and 508b are arranged in two pairs and separated by a relatively narrow main discharge gap G, when the PDP is driven, an electric field intensity peak is formed in proximity to each of the main discharge gaps, and consequently, discharge occurs at a plurality of locations (here, at two separate locations) in the discharge cell 8. Hence, in comparison to previous technologies, the scale of the discharge at the instant that discharge occurs is large, and a favorable scale of discharge can subsequently be guaranteed. Further, in the First Embodiment, because concentrating the electric field in proximity to each of the main discharge gaps G causes a partially intense electric field to be formed and enables discharge to occur more easily, such an arrangement can also be effective in reducing the firing voltage when the PDP is driven.

Subsequently, during the sustain discharge, owing to the provision, by hook patterning, of cut-outs 409 and 509 and the resistance film area being kept smaller than in conventional transparent electrodes 400 and 500, which have a uniform band shape (see FIG. 15), the accumulation of extra charge unlikely to contribute to discharge at the transparent electrode material is suppressed. Because of this, during the sustain discharge when the PDP is being driven, the effect of suppressing what is known as reactive power, which does not contribute to the discharge, is achieved. On the other hand, a certain stored charge is guaranteed via the band-shaped base parts 402 and 502, ensuring that an amount of stored charge is not overly reduced by the cut-outs. Consequently, a certain luminance can be guaranteed, and the PDP exhibits a favorable image display performance.

Further, as the main discharge parts 408a, 408b, 508a and 508b on both sides of the address electrode 11 are provided close to the barrier ribs 30, discharges occurring at the main discharge parts 408a, 408b, 508a and 508b can be brought closer to the phosphor layers 9R, 9G and 9B (see FIG. 15) which have an arc-shaped profile. Consequently, ultra-violet light from the discharge arrives effectively at the phosphor layers 9R, 9G and 9B, and an increase in emission efficiency is achieved.

Further, in the construction of FIG. 1, owing to the provision of the row sections 302 of the barrier ribs 30 between cells adjacent in the y-direction, discharge occurring in each discharge cell 8 is prevented from expanding into adjacent cells, and erroneous discharge due to cross talk and the like is effectively suppressed.

### Second Embodiment

FIG. 2 shows the construction of a discharge cell of the Second Embodiment.

Though the overall construction of the Second Embodiment resembles that of the First Embodiment, the construction of the former is distinguished by the provision of a thick layer area B and thin layer areas A. The thick layer B area, where the film is comparatively thick (protruding approximately 10 μm from the main surface), is provided in a dielectric layer 6 of a front panel FP at a position corresponding to an address electrode 11 of a back panel BP, a position that can be differently described as corresponding to the gaps between adjacent members of opposing parts 406a 406b, 506a, and 506b. The thin layer areas A, where the film is comparatively thin (depressions sinking approximately 5 μm below the main surface), are provided in the same dielectric layer 6 at a positions corresponding to pairs of the main discharge parts 408a, 408b, 508a, and 508b, positions that can be differently described as corresponding to positions of the main discharge gaps G. The thin layer areas A and the thick layer area B can both be formed via a photolithographic method using a photosensitive dielectric sheet, a printing method or the like.

Note that, forming depressions in the dielectric layer covering the display electrodes with the object of reducing the firing voltage has been considered before, but in previous constructions a film disparity (depression depth) of approximately 15 μm to 20 μm was required to effectively reduce the firing voltage. However, though a deep disparity of this type enables a reduction in the firing voltage to be achieved, there is a problem in that the generated discharge is confined to the depression and has difficulty expanding any further. In the present invention, on the other hand, the object is to modulate the potential distribution within the discharge cell and to generate a plurality of electric field peaks, and since, unlike in previous constructions, the firing voltage is not required to be reduced directly, the provision of a disparity inherent in a deep depression is unnecessary. In practice, if a shallow depression is approximately 5 μm deep, like the one described above, or less, the present invention is effective, and the problem of the discharge being confined to the depression does not occur.

In general, the intensity of the electric field generated in the discharge space 38 of a PDP is dependent upon an amount of barrier charge accumulated on the display electrodes 4 and 5, and in the Second Embodiment, this characteristic is exploited to obtain the effects described below. Here, the main discharge gaps G are set to 70 μm.

In the dielectric layer of FIG. 2, typical positions for the areas A and B are indicated for descriptive purposes.

In the Second Embodiment having the above construction, when the PDP is driven, by ensuring the dielectric layer 6 in the thick layer area B is a certain thickness, the capacitance of a portion between the display electrodes 4 and 5 is kept low, and the accumulation of barrier charge suppressed. As this causes the electric field peak to be distributed between two locations in the discharge cell 8, one on either side of the thick layer area B where little barrier charge accumulates, firing positions are formed at the two locations corresponding to the two peaks.

The thin layer areas A, on the other hand, in contrast to the thin layer area B of the dielectric layer 6, are rich in stored barrier charge, and discharge occurs easily there. Hence, in areas corresponding to the thin layer areas A, discharge can take place even at a relatively low firing voltage.

Due to the synergistic effects of the thin layer areas A and the thick layer area B, in the Second Embodiment, in addition to the effects achieved in the First Embodiment, discharge is made to occur even at low firing voltages at the thin layer areas A, and by enabling the discharge to expand at a plurality of locations via the thick layer area B and the like, a sustain discharge of a favorable scale is achieved.

Though the Second Embodiment indicates an example in which both the thick layer area B and the thin layer areas A are provided, a definite effect can be obtained even if only one of the two is provided.

Further, though in the Second Embodiment the barrier ribs 30 were provided in a matrix form, stripe form barriers may be used instead.

Variation 1

The form of the display electrodes 4 and 5 in the First Embodiment is not limited to that shown in FIG. 2. For example, the corners in the opposing, rectangular main discharge parts 408a, 408b, 508a and 508b may be removed to form bevel parts r as shown in FIG. 3. If the corners of the main discharge parts 408a, 408b, 508a, 508b are sharp, under certain circumstances charge becomes over-concentrated at these corners when the PDP is driven, and erroneous discharge occurs. Provision of the bevel parts r is desirable because they diffuse the charge to some extent, and this problem can be effectively prevented.

In the construction of FIG. 3, a portion of each main discharge part 408a, 408b, 508a and 508b is positioned directly over the barrier ribs 30. This construction is desirable because it causes the x-direction width of the discharge cell 8 to be fully employed and wide main discharge parts 408a, 408b, 508a and 508b to be formed. A reduction in the firing voltage can be cited as one of the effects of the present invention. Further, because it is acceptable for the main discharge parts 408a, 408b, 508a and 508b to overlap the barrier ribs 30, some misalignment of the front panel FP and the back panel BP is permissible, and this has the effect of improving yield.

Further, instead of providing the bevel parts r, a technique to round off the corners of the main discharge parts 403a, 403b, 503a, and 503b can be used.

### Third Embodiment

FIG. 4 shows the construction of a discharge cell 8 of a PDP 1 of the Third Embodiment.

The PDP 1 of the Third Embodiment is substantially the same as that of the Second Embodiment, but includes band-shaped extending parts 412a and 512a, which extend from band-shaped base parts 402 and 502 along barrier ribs 30. Further, the extending parts 412a and 512a are respectively provided with L-shaped opposing parts 416a, 416b, 516a and 516b. Hence, in the Third Embodiment, as shown in FIG. 4, main discharge gaps G respectively exist between the opposing parts 416a and 516b, and between the opposing parts 516a and 416b. Thus, in the Third Embodiment, in a discharge cell 8, the main discharge gaps G exist at two locations in the y-direction.

The overall pattern of the display electrodes 4 and 5 is such that adjacent discharge cells 8 are symmetrical in the x-direction about the barrier ribs 30.

Moreover, in the Third Embodiment, thin layer areas A in a dielectric layer 6, resembling those described in the Second Embodiment, are formed at positions (two locations in discharge cell 8) corresponding to the main discharge starting gaps G. Further, in the Third Embodiment too, an amount of accumulated charge necessary for luminance emission is guaranteed by providing band-shaped base parts 402 and 502, which are composed of a transparent electrode material.

Using the PDP 1 of the Third Embodiment having the display electrodes 4 and 5 of the above construction, beneficial effects resembling those of the Second Embodiment are achieved in the following manner. When the PDP is driven and power is supplied to the electrodes 4, 5 and 11 from an external source, in any given discharge cell 8, address discharge occurs between the address electrode 11 and the display electrode (scan electrode) 4. Next, at the beginning of the discharge sustain period, when a pulse is applied to the display electrodes 4 and 5 of the given discharge cell 8, electric field intensity peaks are formed in the main discharge gaps G between the opposing parts 416a and 516b, and between the opposing parts 516a and 416b, and discharge occurs in these portions. Subsequently, at the display electrodes 4 and 5, because the main discharge gaps G exist at two locations in the discharge cell 8, the discharge expands rapidly, and a discharge of a favorable scale is formed across the whole of the opposing parts 416a and 516b and the whole of opposing parts 516a and 416b.

Further, as a result of the cut-outs 409 and 509 and the gaps GG that exist between the opposing parts 416a and 416b and between the opposing parts 516a and 516b, reactive power is effectively prevented.

Here, when the discharge occurs, as peaks in the electric field intensity are formed in each of the thin layer areas A of the protective layer 6, which correspond to the main discharge gaps G in the discharge cell 8, the sustain discharge effectively occurs and expands according to the positions of the peaks, and a great improvement in luminance can be achieved.

Moreover, when the thin layer areas A are provided in a plurality of locations in the discharge cell 8 as in the Third Embodiment, an according number of peaks in the electric field intensity are formed in the discharge cell 8, and a discharge occurs at each peak position. For these reasons, experiments by the inventors showed clearly that the discharge in a cell of this construction expands favorably compared with a construction in which a thin layer area A with a large surface area is provided at one location. For this reason, the thin layer A area may be provided at two or more locations in the cell.

Though in the Third Embodiment an example construction combining the opposing parts 416a, 416b, 516a and 516b, and the thin layer areas A has been indicated, provision the thin layer areas A of the dielectric layer is not strictly necessary.

Further, the number of opposing parts provided on each of the extending parts is not limited to the number in the construction of FIG. 4, and may be varied as appropriate.

### Fourth Embodiment

FIG. 5 shows the construction of the display electrodes of the Fourth Embodiment.

The distinguishing characteristic of the Fourth Embodiment is the provision of cut-outs 411a, 411b, 411c, 511a, 511b, and 511c, three in each of opposing portions of band shaped base parts 410 and 510, which are composed of transparent electrode material, the cut-out shaving a depth less than a y-direction width of the transparent electrodes, and opposing parts 406a, 406b, 506a etc. being formed to both sides of the cut-outs.

Here, a width GG of the cut-outs 411a and 511a is set to be narrower than a width of an address electrode 11, and the cut-outs 411a and 511a are positioned over the address electrode 11. 411b, 411c, 511b and 511c are positioned close to the barrier ribs 30 of the discharge cell 8, resulting in the opposing parts 406a, 406b, 506a, and 506b being widely dispersed in the cell.

In the Fourth Embodiment having the above construction, when the PDP is driven, peaks in electric field intensity are formed in each of the gaps between pairs of opposing parts 406a, 406b, 506a and 506b to both sides of 411a and 511a, and discharge occurs therein. Consequently, substantially the same effects as in the First and Second Embodiments are achieved. Further, because the electrodes of the Fourth Embodiment have a comparatively simple form, effects such as the simplification of the pattering process can be achieved.

Variations 2 and 3

FIG. 6 shows the construction of a variation (Variation 2) of the Fourth Embodiment which differs in that, in the discharge cell 8, the address electrode is divided into two parallel branch sections 11a and 11b, and in that the opposing parts 406a, 406b, 506a and 506b are provided in correspondence with the branch sections 11a and 11b.

This kind of construction is desirable because it enables the address electrode 11 to be positioned close to the various firing positions, and is therefore highly effective in improving the reliability of address discharge and preventing discharge time lag.

Further, in the Fourth Embodiment, the cut-outs 411b, 411c, 511b and 511c are non-essential, and it is acceptable to provide whichever one or more thereof, or to provided none thereof as in Variation 3 shown in FIG. 7.

Note that, though by providing the cut-outs 411b, 411c, 511b and 511c a reduction in reactive power is achieved, it is acceptable to adjust the design of the cut-outs as appropriate according to the accuracy of the alignment required when the front panel FP and the back panel BP are combined. For example, when accuracy requirements are strict, the cut-outs may not be provided at all, may be made larger, or be similarly redesigned.

Experimental Data

FIG. 8 to FIG. 10 show the results of performance measurement experiments performed while varying the design values of the display electrode pattern in PDPs manufactured according to the construction of Variation 3.

FIG. 8 shows the way in which the potential distribution inside the discharge cell changes according to the width of the cut-outs provided in the transparent electrodes. These results indicate the potential in regions to both sides of a centrally located cut-out.

As shown in the drawing, in the case of a conventional construction in which no cut-outs are provided (thick solid line), the potential distribution is a single peak which is broad and even. However, when a cut-out is provided and the depth of the cut-out is increased from 20 μm to 40 μm, 60 μm, and 100 μm (dotted lines and thin solid lines), respectively sharper peaks are generated in the transparent electrode areas (the opposing parts) to both sides of the of the cut-out, and a plurality of potential peaks are formed in the discharge cell 8 accordingly. It is considered that, when potential peaks are clearly present in this way, firing at locations corresponding to the peak positions will occur with more reliability.

FIG. 9 shows data indicating the relationship between a cut-out width and a cut-out length (depth of the missing portion), and the corresponding reactive current. Variation in the luminance of the discharge cell 8 is not considered here, and this data simply indicates the interrelationship between the cut-out and reactive power. It can be ascertained that the deeper the cut-out, the greater the reduction in reactive power, but when the depth exceeds a certain value, the reduction effect saturates. It is also to be noted, however, that if the depth of the cut-out is increased, the surface area of the transparent electrode reduces accordingly.

Thus, there is the demerit, if the cut-outs are over-enlarged with only the reduction effect in mind, of being unable to obtain the benefits of this reduction effect, and even of being unable to obtain the luminance necessary for display. FIG. 10 contains data showing this result. Shown in the drawing is data indicating the relationship between the cut-out width and the cut-out length (depth of the missing portion) and the corresponding reactive current, after performing luminance correction, in which input power is adjusted to guarantee a luminance required for discharge. Here, the value for the emission efficiency of the PDP as a whole is calculated by dividing a luminance value for the whole panel by the sum of the reactive power and the discharge power.

Since the electrode surface area and the luminance are proportional, in constructions in which the cut-out extends to the bus line, such as in those of previous technologies, ensuring sufficient luminance can be said to be at least as important as reducing reactive power. If the luminance drops due to a loss of electrode area from the cut-out, it becomes necessary to increase the number of emissions during the sustain discharge to make up for the drop and maintain luminance. Doing this causes the high-speed driving load on the driving circuitry to increase. There is also a risk, even if the reactive power per unit emission is not particularly high, that achieving a sufficient reduction in reactive power will become very difficult as a consequence of the accumulation in reactive power associated with the increase in the number of emissions. For this reason, it is not desirable for the cut-outs to fully segment the transparent electrode.

The inventors discovered, based on their experiments, that when the width of the rectangular cut-out is between 60 μm and 120 μm inclusive, the depth of the cut-out should be between 10 μm and 40 μm inclusive to obtain the effects of the present invention.

According to the data of FIG. 10 and on the basis that a PDP (of the construction shown in FIG. 15) with display electrodes 4 and 5 which are band shaped and composed of ITO film is used, it is thought to be preferable, with regard to overall PDP efficiency when the PDP is conventionally driven (in such a way that the number of emissions during sustain discharge is not increased to any great extent), that the reactive power ratio is substantially 1.0 or less, which is to say that the depth of the cut-out should be 20 μm or less.

Note that while FIG. 8 to FIG. 10 show only measurements taken at a few slit widths of 120 μm or less, the above observations can, it is considered, be applied by appropriate analogy to slit widths other than the measured ones.

Further, the form of the cut-outs can be varied as appropriate. Besides existing between the hook-shaped opposing parts (see FIG. 1) of the First to Third Embodiments and being rectangular in the Fourth, the cut-outs can, for instance, be circular, have a conic section form, be polygonal, or be wedge-shaped.

### Fifth Embodiment

The Fifth Embodiment has the distinguishing characteristic of a second dielectric layer being provided on the protective layer. FIG. 11 and FIG. 12 are, respectively, a plan view of a PDP of the Fifth Embodiment and a cross sectional view taken along A-A′ in the plan view. Though in FIG. 12, for the sake of convenience, the front panel FP and the back panel BP are depicted as separated entities, they are of course bonded together.

In the Fifth Embodiment a pair of display electrodes 4 and 5 are, as shown in FIG. 11, constructed from bus lines 401 and 501, and band-shaped base parts 400 and 500, which are composed of a transparent material and disposed inside the bus lines 401 and 501 in the gap between the pair of display electrodes 4 and 5. Here, a main discharge gap is set to be 60 μm. Further, an example in which the address electrode 11 is divided to provide two parallel branch sections 112a and 112b in the discharge cell 8 is shown. These branch sections 112a and 112b are for making discharge reliable and for ensuring that barrier charge is formed, but the following effects can obtained even if they are not provided.

Display electrodes 4 and 5 are formed on the surface of a front panel glass 2, and so as to cover this surface, a dielectric layer 6, and a protective layer 7 composed of a Magnesium Oxide film (MgO) are layered thereon in the stated order (see FIG. 15). The distinguishing characteristic of the Fifth Embodiment, however, is that a second dielectric layer 70, extending in the y-direction, is formed on the protective layer 7 so as to pass through the center of the discharge cell 8. The second dielectric layer 70 is provided with the object of reducing an amount of stored barrier charge by suppressing, in the region where it is provided, a capacitance formed between the display electrodes 4 and 5 and a discharge space 38. The second dielectric layer 70 is manufactured from a material such as dielectric glass, alumina, silicon oxide, and is made up of a main part 701, of thickness 40 μm and of width 65 μm, and an extending part 702, which extends so as to be overlapped by a black matrix BM. Note that though the film thickness of the second dielectric layer 70 is not limited to the above value, is preferable to give the film some degree of thickness because this enables the capacitance formed between the display electrodes 4 and 5 and the discharge space 38 to be suppressed.

Using the PDP of the Fifth Embodiment with the above construction, effects similar to those of the First Embodiment are achieved. Namely, when electricity is supplied to the display electrodes 4 and 5 during driving, barrier charge accumulates inside the discharge cell 8 and discharge occurs. This discharge is caused by an electric field formed as a result of the accumulation of barrier charge. In the Fifth Embodiment, however, because the second dielectric layer 70 is formed on the protective layer 7, the amount barrier charge stored in this area falls. Consequently, in the discharge cell 8, the intensity of the electric field generated in the discharge space 38 is altered to show an electric field distribution (potential distribution) with peaks at two locations split by the second dielectric layer 70, and discharge occurs, even at low firing voltages, at positions corresponding to these two peaks in electric field intensity. As a result, the effect of a widely expanded discharge in the discharge cell 8 is achieved in the Fifth Embodiment in a similar way to the First to Fourth Embodiments.

Further, in the Fifth Embodiment, since transparent electrode material is not removed, the problem of insufficient accumulation of charge, which leads to a drop in luminance, does not occur.

In addition, in the Fifth Embodiment, the provision of the extending parts 702 of the second dielectric layer 70, as shown in FIG. 11, so as to divide adjacent cells in the column direction effectively enables problems such as cross-talk to be prevented.

The inclusion of a phosphor inside and on the surface of the second dielectric layer 70 results in improvements in luminance and emission efficiency, and is therefore preferable.

Moreover, in the Fifth Embodiment, though stripe-form barrier ribs 30 were used, matrix formation barrier ribs are also acceptable.

Further, though in the Fifth Embodiment a construction in which cut-outs are not provided in the transparent electrodes 400 and 500 is used, to obtain a further reduction in the reactive power, cut-outs may be provided in the transparent electrodes 400 and 500 in a similar way to the Fourth Embodiment. Where this is the case, it is preferable to provide the second dielectric layer 70 in correspondence with the position of the cut-outs.

Moreover, if the cut-outs are formed in correspondence with the position of the address electrode 11, and the second dielectric layer 70 is provided in alignment with the respective positions of the address electrode 11 the cut-outs, peaks in the intensity of the electric field will be more easily formed to both sides of the cut-outs.

Variations 4 and 5

The present invention is not limited to the construction of the Fifth Embodiment, and the following variations are also possible.

FIG. 13 shows Variation 4, which has a construction in which, in the discharge cell 8, a second dielectric layer 70 is disposed in a position that both aligns with a position of an address electrode 11, and corresponds to a main discharge gap G of a pair of display electrodes 4 and 5.

This kind of construction is effective when, as in the Fifth Embodiment, there are no great problems with cross talk between discharge cells 8 adjacent in the y-direction. Further, because of the simple form of the second dielectric layer 70 in comparison to in the second dielectric layer of the Fifth Embodiment, this construction has the additional merit of being relatively simple to manufacture.

FIG. 14 indicated below has a construction in which a regular band-shape is used for an address electrode 11. The construction is characterized by a second dielectric layer 70 having a rectangular form resembling that of Variation 4, and by an address electrode 11 width being greater a second dielectric layer 70 width.

If the above construction is used, in addition to the effects of Variation 4, because the relative dispositions of the second dielectric layer 70 and the address electrode 11 cause the firing positions in the pair of display electrodes 4 and 5 to include a portions located over the address electrode 11, the beneficial effect of more reliable address discharge is achieved.

As another variation of the Fifth Embodiment, a construction can be used in which, instead of forming the second dielectric layer 70, the protective layer 7 is not provided in some regions at locations in the y-direction. This construction uses the property that barrier charge is difficult to store in regions where the protective layer is not formed. This construction is based on the principal of discharge occurring at two locations in the discharge cell 8, and makes use of variation in the electric field intensity distribution in a similar way to when the second dielectric layer 70 is formed.

Additional Items

In the First to Fifth Embodiments, constructions in which pairs of display electrodes are similarly disposed in the column direction (the so-called ABAB arrangement) are shown. However, the present invention is not limited to this arrangement, and may equally be of a construction in which scan electrodes are disposed adjacent to one another, as are the sustain electrodes, and these pairs of adjacent display electrodes alternate (the so-called ABBA arrangement).

### INDUSTRIAL APPLICABILITY

The PDP of the present invention is of use in lightweight large screen televisions and the like, and is also suitable for application in devices such as industrial-use display devices.

### Brief Description of the Drawings

FIG. 1 shows a construction of a discharge cell in a PDP of the First Embodiment;

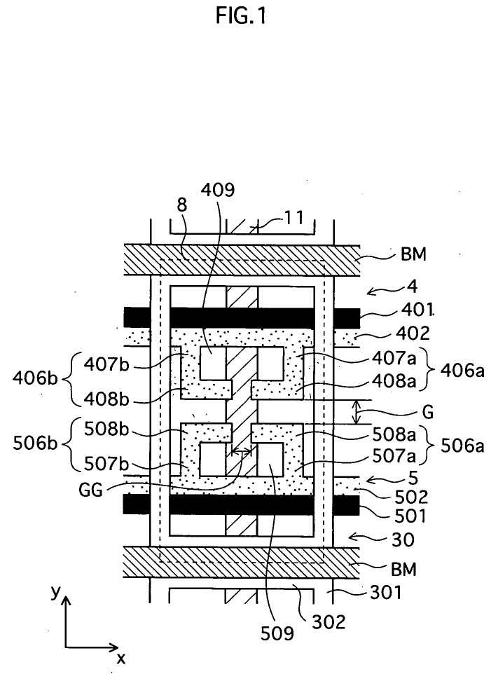

FIG. 2 shows a construction of a discharge cell in a PDP of the Second Embodiment;

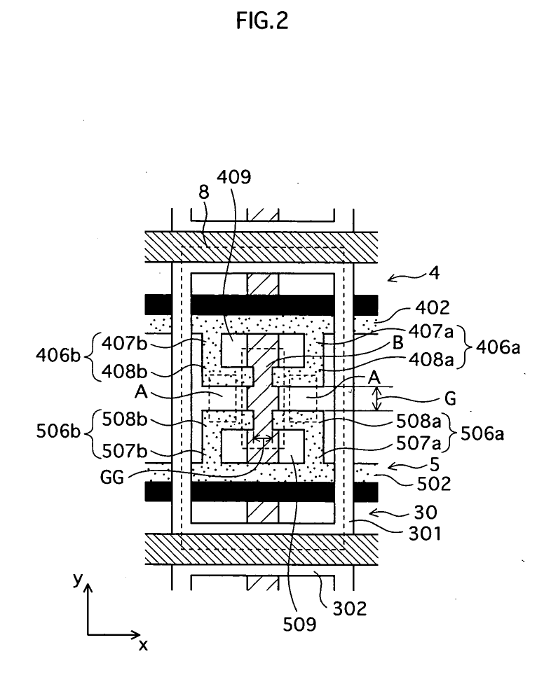

FIG. 3 shows a construction of a discharge cell in a PDP of a variation of the Second Embodiment;

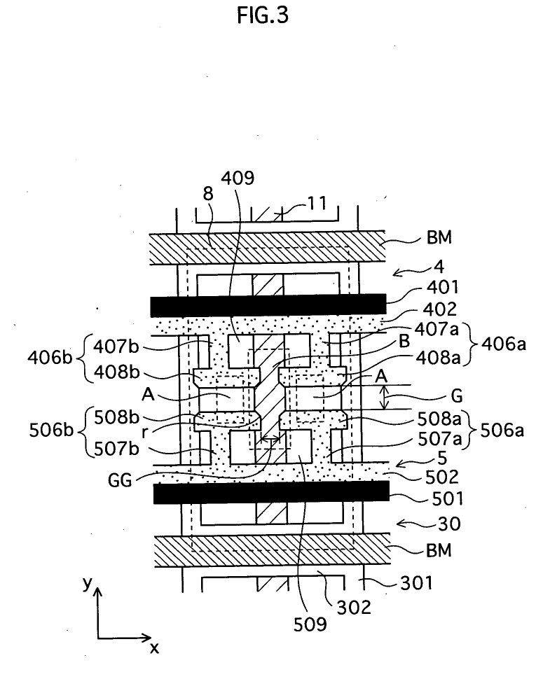

FIG. 4 shows a construction of a discharge cell in a PDP of the Third Embodiment;

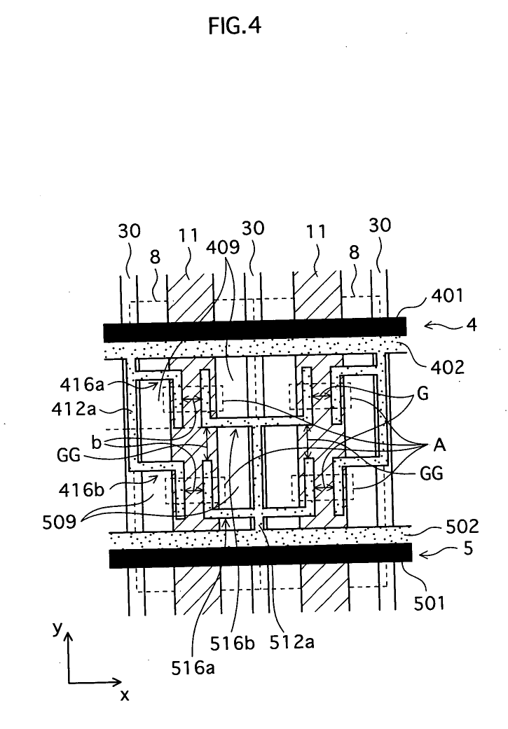

FIG. 5 shows a construction of a discharge cell in a PDP of the Fourth Embodiment;

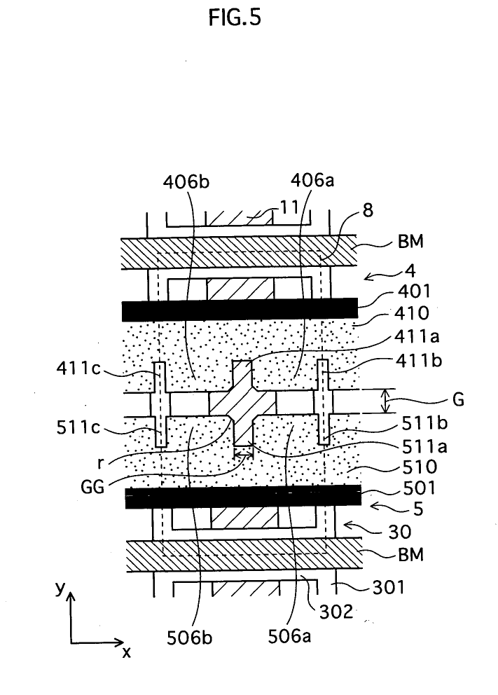

FIG. 6 shows a construction of a discharge cell in a PDP of a variation of the Fourth Embodiment;

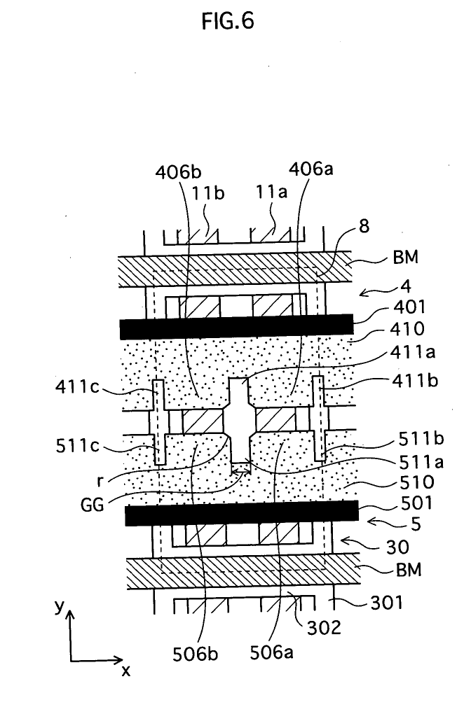

FIG. 7 shows a construction of a discharge cell in a PDP of a variation of the Fourth Embodiment;

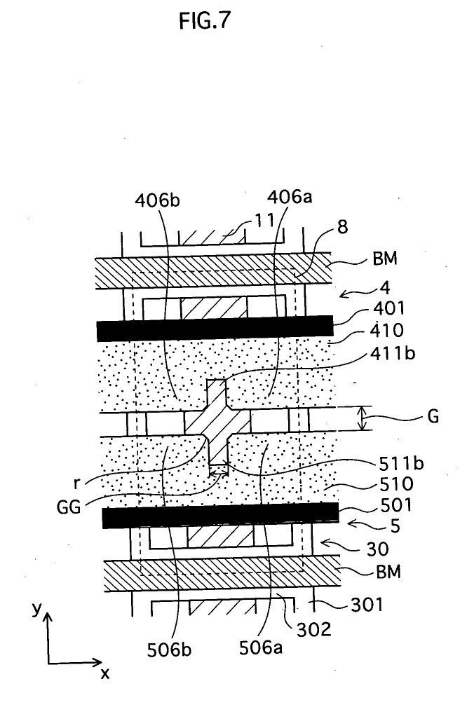

FIG. 8 shows example data (relationship between the cut-out and potential distribution);

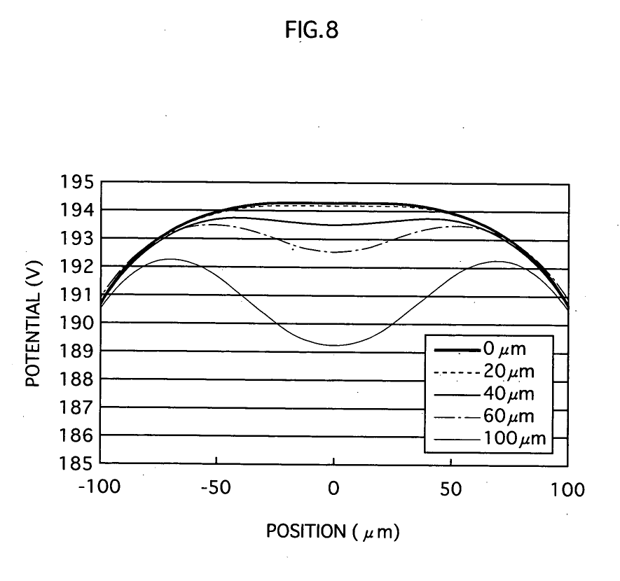

FIG. 9 shows example data (relationship between the cut-out and reactive power);

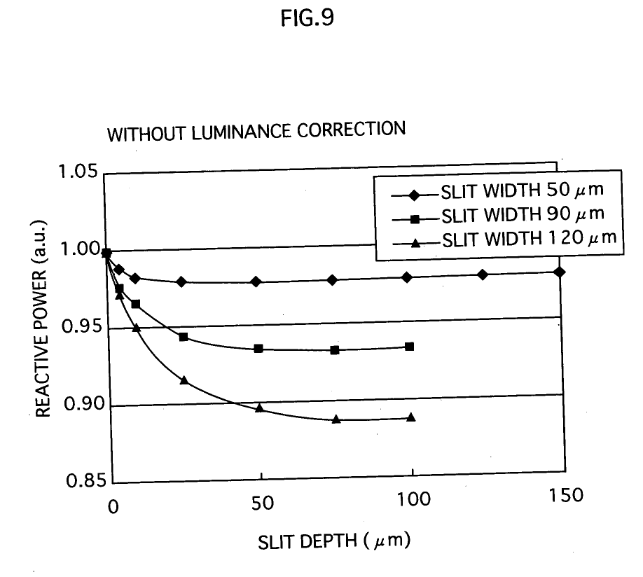

FIG. 10 shows example data (relationship between the cut-out and reactive power);

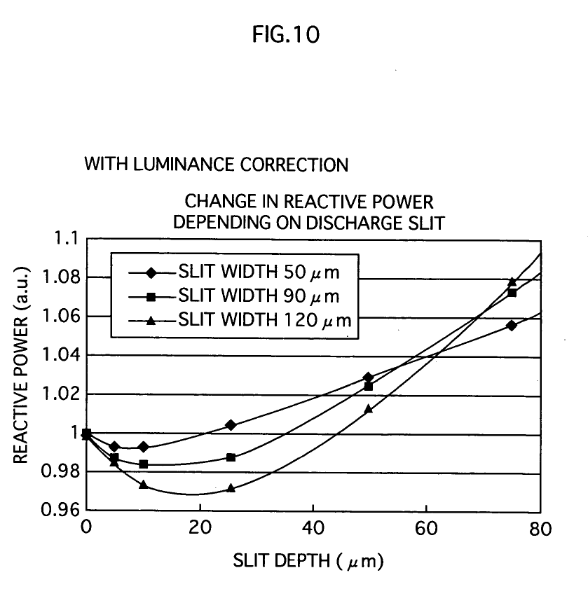

FIG. 11 shows a construction of a discharge cell in a PDP of the Fifth Embodiment;

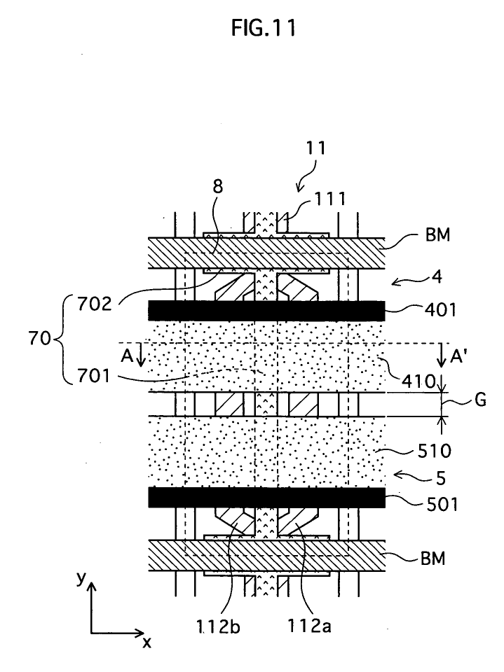

FIG. 12 shows (in cross-section) a construction of a discharge cell in a PDP of the Fifth Embodiment;

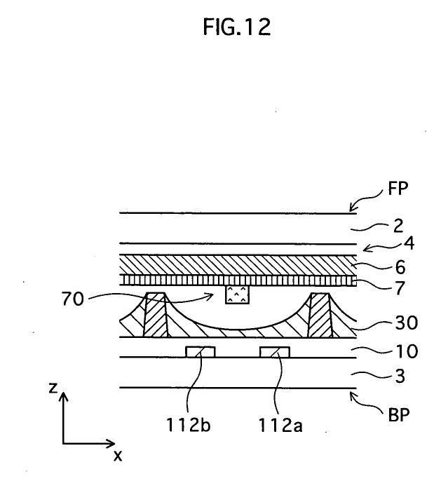

FIG. 13 shows a construction of a discharge cell in a PDP of a variation of the Fifth Embodiment;

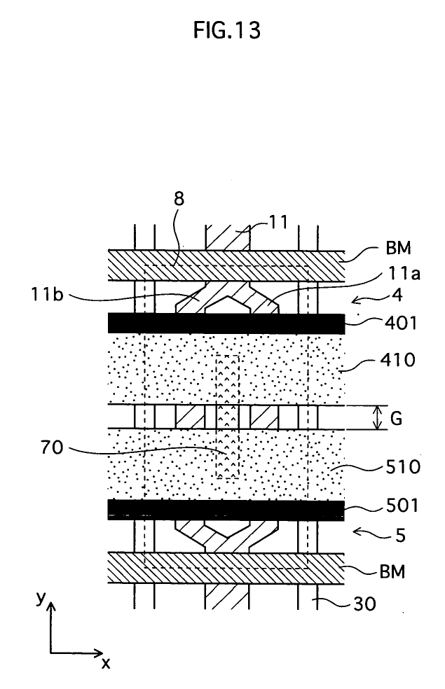

FIG. 14 shows a construction of a discharge cell in a PDP of a variation of the Fifth Embodiment; and

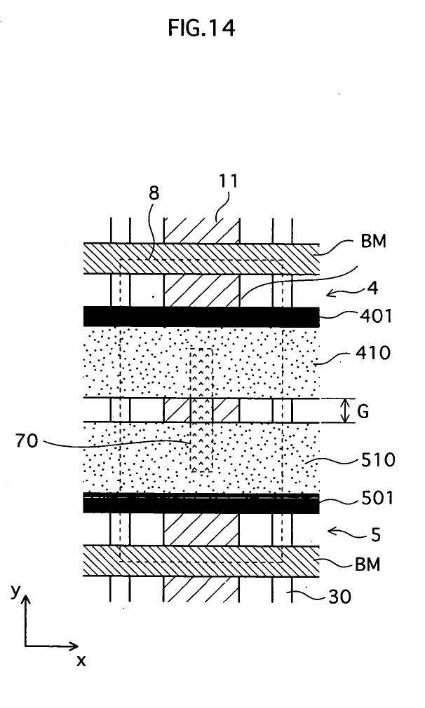

FIG. 15 is a partial perspective view showing the construction of a general PDP.

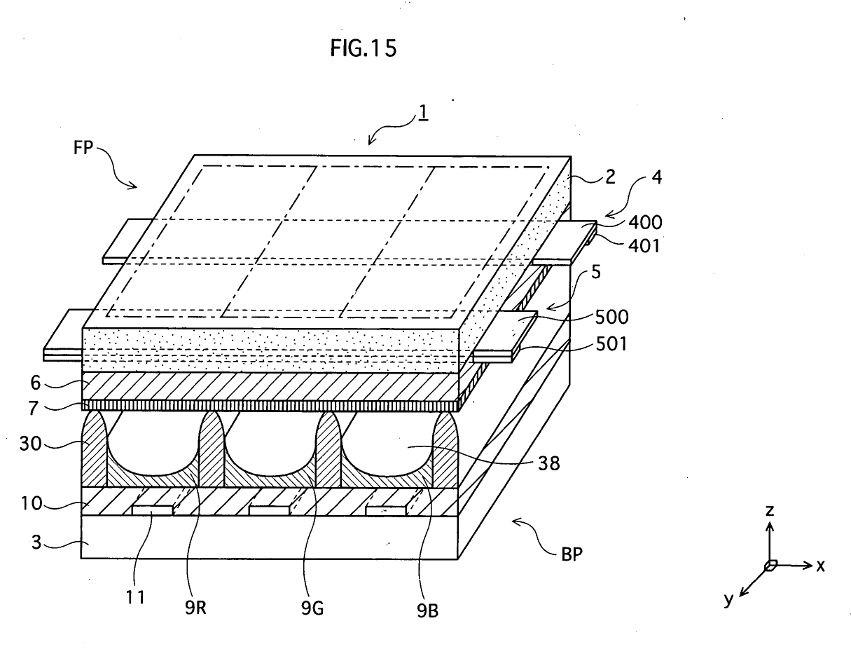

1. A plasma display panel in which a plurality of pairs of display electrodes extending in a row direction are disposed on a surface of a first substrate and a plurality of discharge cells are formed along each pair of display electrodes, wherein
at least within each discharge cell,
each display electrode of the pair of display electrodes comprises a bus line and a band-shaped electrode member that is electrically connected to the bus line, the band-shaped electrode member extending in the row direction and being disposed at least mainly on a same side of the bus line as a gap between the pair of display electrodes, and
each band-shaped electrode member has at least one cut-out formed from a gap-side edge towards the bus line, each cut-out having a length that is shorter than a distance between the gap-side edge and the bus line.

2. The plasma display panel of claim 1, wherein
each bus line is composed of a metallic material and each band-shaped electrode member is a transparent electrode.

3. The plasma display panel of claim 1, wherein
each cut-out has one of a rectangular form, a wedge form, a polygonal form, and a circular form.

4. The plasma display panel of claim 1, wherein
when a row direction width of each cut-out is in a range of 60 μm to 120 μm inclusive,
a column direction length of each cut-out is in a range of 10 μm to 40 μm inclusive.

5. The plasma display panel of claim 4, wherein
the column direction length of each cut-out is in a range of 10 μm to 20 μm inclusive.

6. The plasma display panel of claim 1, wherein
the first substrate opposes a second substrate across a discharge space, a plurality of address electrodes being disposed on the second substrate in a stripe pattern, and
in each discharge cell, the cut-outs in the pair of display electrodes are located opposite each other, and the first substrate and the second substrate are arranged so that the cut-outs are in correspondence with an address electrode that is in the discharge cell.

7. The plasma display panel of claim 6, wherein
the cut-outs are symmetrical about the address electrode.

8. The plasma display panel of claim 6, wherein
a row direction width of each cut-out is narrower than a width of the address electrode.

9. The plasma display panel of claim 6, wherein
at least within each discharge cell, the address electrode comprises a plurality of branch parts extending in the column direction.

10. The plasma display panel of claim 1, wherein
on the first substrate, a first dielectric layer and a protective layer have been layered in the stated order so as to cover the display electrodes, and
in each discharge cell, on the protective layer, a second dielectric layer is provided in correspondence with positions of the cut-outs.

11. The plasma display panel of claim 10, wherein
the second dielectric layer comprises a band-shaped main part whose length is in the column direction, and
the cut-outs are in correspondence with the address electrode, and the main part is provided directly over the address electrode, the main part and the address electrode sandwiching discharge space therebetween.

12. The plasma display panel of claim 11, wherein
a row direction width of the main part is less than a width of the address electrode.

13. The plasma display panel of claim 1, wherein
auxiliary barrier ribs extending in the row direction are individually provided between discharge cells that are adjacent in the column direction.

14. The plasma display panel of claim 1,-wherein
each band-shaped electrode member is provided with a plurality of opposing parts, one opposing part being provided on each side of each cut-out, and
at least one main discharge gap is provided in each location at which two opposing parts belonging to the respective band-shaped electrode members of the pair of display electrodes oppose one another.

15. The plasma display panel of claim 14, wherein
each opposing part includes a connecting part extending in the column direction and a discharge part extending from the connecting part in the row direction, and
a main discharge gap exists in each location at which two discharge parts belonging to the respective band-shaped electrode members of each pair of display electrodes oppose each other.

16. The plasma display panel of claim 15, wherein
the connecting part of each opposing part is provided with a plurality of discharge parts, and
in the discharge cell, a plurality of main discharge gaps are provided in the column direction between opposing parts that belong to the respective electrode members.

17. The plasma display panel of claim 15, wherein
each discharge part is band-shaped and has a length in the row direction.

18. The plasma display panel of claim 14, wherein
the first substrate is disposed opposite a second substrate on which a plurality of address electrodes are disposed in a stripe form,
in each discharge cell, opposing parts belonging to the respective electrode members of the pair of display electrodes are located opposite each other, and
the first substrate and the second substrate are arranged so that each gap between opposing parts that are adjacent and of the same polarity corresponds with a position of the address electrode in the discharge cell.

19. The plasma display panel of claim 18, wherein
in each discharge cell, the opposing parts are disposed symmetrically about the address electrode.

20. The plasma display panel of claim 18, wherein
each gap between opposing parts that are adjacent and of the same polarity is narrower than a width of the address electrode.

21. The plasma display panel of claim 14, wherein
a dielectric layer is provided so as to cover the display electrodes on the surface of the first substrate on which the display electrodes are arranged, and
in each discharge cell,
at least one layer area is provided in the dielectric layer in correspondence with each position of the main discharge gaps.

22. The plasma display panel of claim 14, wherein
a dielectric layer is provided so as to cover the display electrodes on the surface of the first substrate on which the display electrodes are arranged, and
in each discharge cell,
at least one thick layer area is provided in the dielectric layer in correspondence with positions of gaps between adjacent opposing parts of a same polarity.

23. The plasma display panel of claim 14, wherein
auxiliary barrier ribs extending in the row direction are individually provided between discharge cells that are adjacent in the column direction.
